(19) United States
(12) Patent Application Publication
(10) Pub. No.: US 2018/0233149 A1
(43) Pub. Date: Aug. 16, 2018

(54) Voice Activated Assistance System

(71) Applicant: Wal-Mart Stores, Inc., Bentonville, AR (US)

(72) Inventors: Todd Davenport Mattingly, Bentonville, AR (US); David G. Tovey, Rogers, AR (US)

(21) Appl. No.: 15/879,684

(22) Filed: Jan. 25, 2018

Related U.S. Application Data
(60) Provisional application No. 62/458,109, filed on Feb. 13, 2017.

(51) Int. Cl. G10L 15/26; H04W 4/024; H04W 4/33; H04M 1/725; G06Q 30/06

(52) U.S. Cl. CPC G10L 15/265; H04W 4/024; G06Q 30/0639; H04M 1/72597; H04W 4/33

(57) ABSTRACT

Described in detail herein are systems and methods for a voice activated assistance system. A user provides voice input to a computing system, including a microphone, and an interactive display. The computing system identifies an object based on the voice input, queries a database for the object to obtain a location of the object. The computing system creates a session including a map to the location of the object. The computing system detects a mobile device within a specified distance of the computing system. The computing system transfers the session including the map to the location of the object to the mobile device within the specified distance of the computing system.

### CROSS-REFERENCED APPLICATIONS

This application claims priority to U.S. Provisional Patent Application Ser. No. 62/458,109, entitled “A VOICE ACTIVATED ASSISTANCE SYSTEM,” filed on Feb. 13, 2017, which is hereby incorporated by reference in its entirety.

### BACKGROUND

Large amounts of physical objects can be disposed in a facility. It can be difficult to navigate throughout the facility without knowledge of locations of the physical objects.

### BRIEF DESCRIPTION OF DRAWINGS

Illustrative embodiments are shown by way of example in the accompanying drawings and should not be considered as a limitation of the present disclosure. The accompanying figures, which are incorporated in and constitute a part of this specification, illustrate one or more embodiments of the invention and, together with the description, help to explain the invention. In the figures:

FIG. 1 depicts a computing system in disposed in a facility according to an exemplary embodiment;

FIG. 2 depicts a mobile device according to an exemplary embodiment;

FIG. 3 illustrates an exemplary voice activated assistance system in accordance with an exemplary embodiment;

FIG. 4 illustrates an exemplary computing device in accordance with an exemplary embodiment; and

FIG. 5 is a flowchart illustrating a process of the voice activated assistance system according to an exemplary embodiment.

### DETAILED DESCRIPTION

Described in detail herein are systems and methods for a voice activated assistance system in a facility.

In exemplary embodiments, a computing system disposed at a static location a facility (e.g., a kiosk) can receive, via a microphone an output of the microphone that is generated in response to a voice input of a user. The computing system can establish a session in response to the output of the microphone that is unique to the user that provided the voice input. The computing system can determine the voice input is associated with one or more physical object disposed in the facility and/or can request addition input to determine what assistance the user is requesting (e.g., where is the bathroom, where is this specific object, where is someone I can speak with). The executed session of the computing system can query a database to identify information pertaining to the user's request. For example, the database can be queried to identify the location of one or more physical objects in the facility identified in the user's request. In response to retrieving the location, the computing system can display a map indicating a route from the computing system to the location of the one or more physical objects in the facility on an interactive display of the computing system. The map can associated with the session created by the computing system.

The computing system can detect a mobile device associated with the user is within a specified distance of the microphone before, during, or after the user inputs the request. The mobile device can initiate an application in response to being detected. When the computing system detects that the mobile device associated with the user moves beyond the specified distance from the microphone, the computing system can automatically transfer the session to the mobile device to render the map on a display of the mobile device and to receive further voice inputs from a microphone of the mobile device.

In exemplary embodiments, a voice activated assistance system in a retail facility includes a first microphone disposed at a specified location in a facility and a computing system in communication with the first microphone. The computing system includes a database and an first interactive display. The computing system with an assistance environment is programmed to receive an output of the first microphone. The output can be generated in response to a voice input of a first user. The computing system with an assistance environment is also programmed to establish a first session in response to the output of the first microphone that is unique to the first user, determine the voice input is associated with one or more physical object disposed in the facility, query (via the first session) the database to identify the location of the one or more physical objects in the facility, and display on the first interactive display a map indicating a route from the computing system to the location of the one or more physical objects in the facility. The map can be associated with the first session. The computing system with an assistance environment is also programmed to detect a mobile device associated with the user is within a specified distance of the first microphone, where the mobile device initiates an application in response to being detected. The computing system with an assistance environment is further programmed to detect the mobile device moved beyond the specified distance from the first microphone and transfer, from the computing system, the first session to the mobile device to render the map on a display of the mobile device and to receive further voice inputs from a second microphone of the mobile device in response to detecting that the mobile device moved beyond the specified distance.

The computing system is further configured to render the map indicating the route from a location of the mobile device to the location of the one or more physical objects in the facility. The mobile device is configured to generate a haptic response effect in response to the mobile device moving towards or away from the location of the one or more physical objects. The computing system is further programmed to determine the shortest route from the computing system to the location of the one or more physical objects.

A printer operatively coupled to the computing system. The printer is configured to receive instructions to print a set of information associated with the one or more physical objects, and print the set of information associated with the one or more physical objects. Speakers are operatively coupled to the computing system and disposed in proximity to the first microphone to provide audible feedback to the first user in response to the voice input.

Upon transferring the session from the computing system to the mobile device, the computing system is configured to release the first microphone from the session, and in response to receiving voice input from a second user via the first microphone, the computing system is configured to establish a second session associated with the second user. The first and second sessions can be executed concurrently by the computing system.

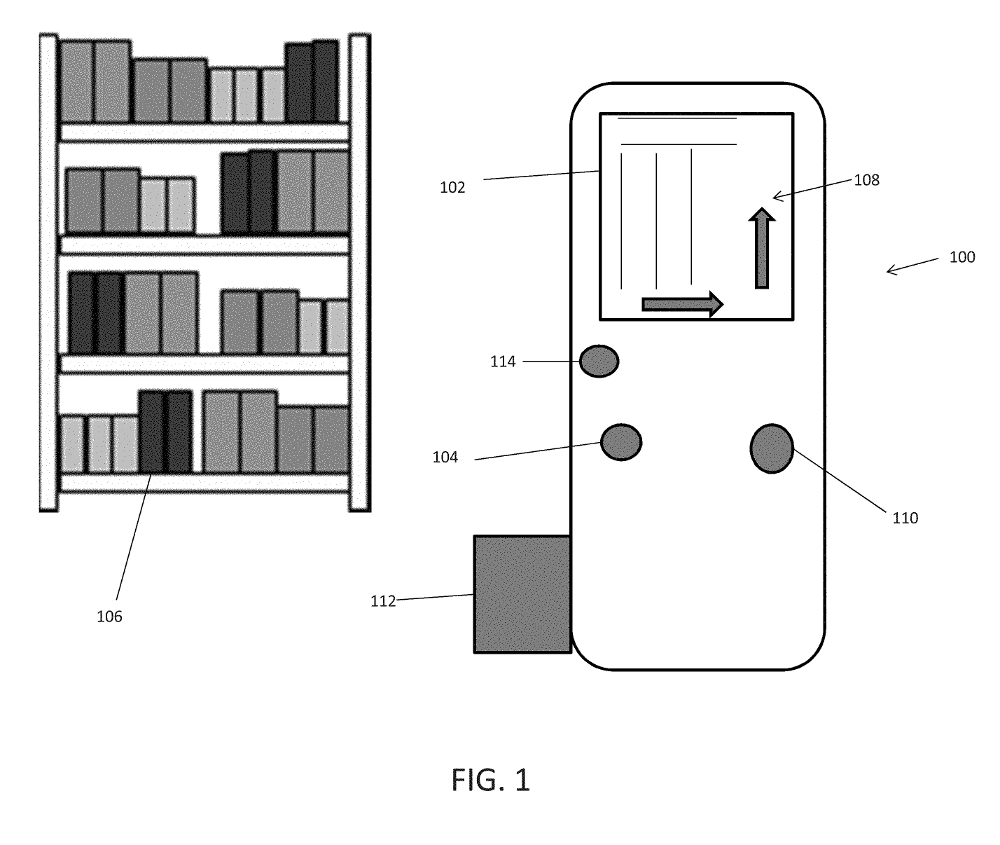

FIG. 1 illustrates a computing system in disposed in a facility according to an exemplary embodiment. The computing system 100 can be statically disposed in a facility. For example, the computing system 100 can be a kiosk or terminal disposed in a facility (e.g., at an entrance of the facility). The computing system 100 can include an interactive display 102 and a microphone 104 that can be configured to pick up audible sounds. Physical objects 106 can be disposed in the facility.

A user can speak into the microphone 104 and attempt to inquire about physical objects 106 disposed in the facility. In response to, detecting an audible inquiry from the user, the computing system 100 can establish a session associated with the user. The session can be configured to maintain a state of the interaction between the user and the computing system. The computing system 100 can display information associated with the physical objects 106 on the interactive display 102. In some embodiments, the computing system 100 can display an interactive map 108 on the interactive display, indicating the location of the physical objects 106 within the facility and directions and/or a route to the physical objects 106. The computing system 100 can also include a communication device 108. The communication device 110 can be any Near Field Communication (NFC) device such as a Bluetooth® receiver. The communication device 110 can detect a mobile device within a specified distance (e.g., based on an output of the mobile device). The mobile device can belong to the user communicating with the computing system 100. In some embodiments, the communication device 110 can detect the mobile device based on detecting the device that is generating the highest signal strength. The communication device 110 can pair with the mobile device, in response to receiving an affirmation to a permission request to pair with the mobile device.

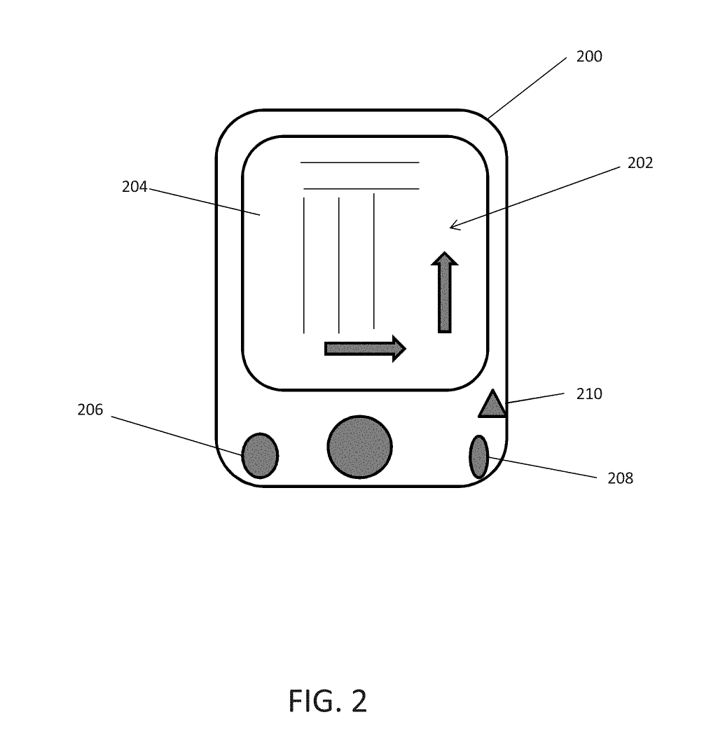

In some embodiments, the user with the mobile device can move away from the computing system 100 while the session still exists. For example, the user with the mobile device can move away from the computing system after receiving the requested information. In the event the communication device 110 is paired with the mobile device, the communication device 108 can detect the mobile device has moved away from the computing system 100 more than a specified distance (e.g., the signal strength of the signal output be the mobile device decreases beyond a specified threshold or the communication channel established between the device as a result of the pairing can be terminated). In response to determining, the mobile device has moved away from the computing system 100 by more than a specified distance, the communication device 110 can transfer the session from the computing system 100 to the mobile device, and in response to the session being transferred to the mobile device, the information (such as the interactive map 108) can be displayed on an interactive display of the mobile device and the computing system can release the microphone of the computing system from the session so that it is available to initiate another session with another user. The mobile device will be discussed in further detail with respect to FIG. 2.

In some embodiments, a printer 112 can be connected to the computing system 100. The printer 112 can be configured to print out the information displayed on the interactive display 102. In another embodiment, the computing system 100 can include speakers 114. The speakers 104 can be configured to generate audible feedback to the user.

FIG. 2 is a block diagram of a mobile device according to an exemplary embodiment. A mobile device 200 can include an interactive display 204, a microphone 206, a haptic device 208, and a communication device 210 in addition to one or more processing device, memory, and speakers . As mentioned above the mobile device 200 can pair with the computing system. The mobile device 200 can pair with the computing system using the communication device 210. The communication device 210 can be any RF or NFC device such as Bluetooth®. The mobile device 200 can receive the session executed on the computing system, via the communication device 210. The session can include the information displayed on the interactive display which can be dynamically transferred to the interactive display 204 of the mobile device 200. The session can also include further inquiries a user made at the computing system. For example, a user can request the location of multiple physical objects disposed in a facility. The computing system can display an interactive map, indicating the location of the of the first one of the physical objects of the multiple objects disposed in the facility. The computing system can also determine the locations of the remaining physical objects. The session can include the locations of the remaining physical objects, so that when the user is able to locate the first physical object, the session generates a another interactive map indicating the location of the first, second or third physical objects of the multiple objects.

In the event, an interactive map 202 is displayed on the interactive display 204 of the mobile device 200, the mobile device can dynamically provide interactive guidance and directions and/or route to the physical object. For example, mobile device 200 can have a location module to determine the location of the mobile device, and the interactive display can display an indication of the location of the mobile device as the user moves throughout the facility. The mobile device can provide audible directions to the user, as well as indicating directions on the interactive display. The mobile device 200 can also generate haptic effects using the haptic device 208 to indicate the user is moving toward the physical object or moving away from the physical object. A different haptic effect can be generated if the user is moving toward the physical object as opposed to moving away from the physical object. The haptic effect can be various types of tactile effects.

In some embodiments, the user can have further inquiries associated with various physical objects disposed in the facility. The user can communicate the inquiries audibly using the microphone 206. The communication device 208 can communicate the inquiries to the computing system. The mobile device 200 can receive information associated with the additional inquiries and display the information on the interactive display 204.

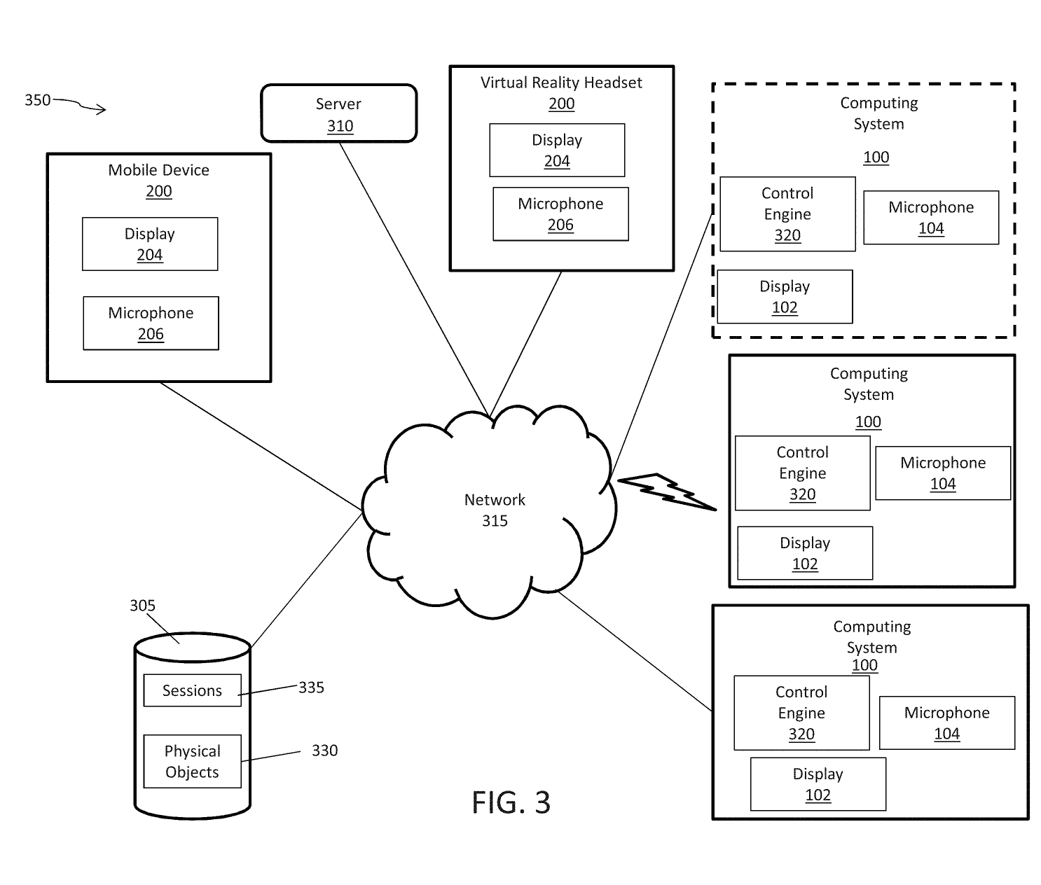

FIG. 3 illustrates an exemplary voice activated assistance system in accordance with an exemplary embodiment. The voice activated assistance system 350 can include one or more databases 305, one or more servers 310, one or more computing systems 300, and one or more mobile devices 200. In exemplary embodiments, the computing system 100 is in communication with one or more of the databases 305, the server 310, the mobile devices 200 via a communications network 315. The computing system can also form a direct wireless connection with the mobile device 200. The computing system 100 can execute one or more instances of the control engine 320. The control engine 320 can be an executable application residing on the computing system 300 to implement the voice activated assistance system 350 as described herein.

In an example embodiment, one or more portions of the communications network 315 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing system 100 includes one or more computers or processors configured to communicate with the databases 305, the server 310, the mobile devices 200 via the network 315. The computing system 100 hosts one or more applications configured to interact with one or more components of the voice activated assistance system 350. The databases 305 may store information/data, as described herein. For example, the databases 305 can include a physical objects database 330 and a sessions database 335. The physical objects database 330 can store information associated with physical objects. The sessions database 335 can store information associated with sessions, such as states of the sessions. The databases 305 and server 310 can be located at one or more geographically distributed locations from each other or from the computing system 100. Alternatively, the databases 305 can be included within server 310 or computing system 100.

In one embodiment, a user can audibly speak into the microphone 104 and attempt to inquire about physical objects 106 disposed in the facility. The computing system 100 can receive the audible input from the microphone 104 and execute the control engine 320 in response to receiving the audible input. In response to, detecting the audible inquiry from the user, the control engine 320 can execute a session associated with the user. The control engine 320 can store the session in the sessions database 335. The control engine 320 can execute speech, voice or audio recognition on the audible input. The control engine 320 can use acoustic and linguistic modeling to execute the speech, voice or audio recognition. The control engine 320 can parse the audible input and determine whether the audible input is associated with one or more physical objects disposed in a facility. The control engine 320 can determine the audible input is associated with one or more physical objects based on information associated with the physical object. The information can be one or more of: name, alphanumeric identifier and/or type of physical object. In the event the computing system 100 cannot recognize the audible input the computing system 100 can discard the audible input.

The control engine 320 can query the physical objects database 330 to retrieve information associated with the physical objects included in the audible input. The control engine 320 can store the information associated with the physical objects included in the audible input in the sessions database 335 corresponding to the executed session. The control engine 320 can display information associated with the physical objects on the interactive display. In some embodiments, the control engine 320 can display an interactive map on the interactive display 102, indicating the location of the at least one of the physical objects within the facility and directions to the physical object. In some embodiments, the interactive map can indicating the location of the of a first one of the physical objects of the multiple objects disposed in the facility. The control engine 320 can also determine the locations of the remaining physical objects. The control engine 320 can store the locations of the remaining physical objects in the sessions database corresponding to the executed session can include the locations of the remaining physical objects, so that when the user is able to locate the first physical object, the session generates a another interactive map indicating the location of the first, second or third physical objects of the multiple objects. The control engine 320 (via the communication device 110 as shown in FIG. 1) can detect a mobile device 200 within a specified distance. The mobile device can belong to the user communicating with the computing system 100. In some embodiments, the control engine 320 can detect the mobile device based on detecting the device that is generating the highest signal strength. The control engine 320 can pair with the mobile device, in response to receiving an affirmation to a permission request to pair with the mobile device. In some embodiments, the control engine 320 can transmit a message to the mobile device 200 requesting to pair with the mobile device 200. In response to receiving an affirmative response the mobile device 200 can pair with the computing system. Once the mobile device 200 and the computing device 100 are paired, the control engine 320 can associate the executed session with the user, with the mobile device 200. In some embodiments, in response to pairing with the mobile device 200 the control engine 320 can extract a mobile device identifier from the mobile device 200. The mobile device identifier can be one or more of Unique Device ID (UDID), the International Mobile Equipment Identity (IMEI), Integrated Circuit Card Identifier (ICCID) and/or the Mobile Equipment Identifier (MEID). The mobile device identifier can be used to associate the executed session with the mobile device 200. In some embodiments, the mobile device 200 can automatically launch an application in response to pairing with the computing system 100.

The user with the mobile device 200 can move away from the computing system 100 after receiving the requested information. In the event the computing system 100 has paired with the mobile device 200, the control engine 320 can detect the mobile device has moved away from the computing system 100 more than a specified distance. In response to determining, the mobile device 200 has moved away from the computing system 100, e.g., by more than a specified distance, the control engine 320 can transfer the session from the computing system 100 to the mobile device 200. In response to the session being transferred to the mobile device, the information (such as the interactive map) can be displayed on an interactive display 204 of the mobile device 200. Once the secession has been transferred to the mobile device 200, the computing system 100 can release the microphone of the computing system from the session and can execute a new session with a new user via the microphone.

In the event, an interactive map 202 is displayed on the interactive display 204 of the mobile device 200, the mobile device can dynamically provide interactive guidance and directions to the physical object. For example, mobile device 200 can have a location module to determine the location of the mobile device, and the interactive display can display an indication of the location of the mobile device as the user moves throughout the facility. The mobile device can provide audible directions to the user, as well as indicating directions on the interactive display. The mobile device 200 can also generate haptic effects using a haptic device to indicate the user is moving toward the physical object or moving away from the physical object. A different haptic effect can be generated if the user is moving toward the physical object as opposed to moving away from the physical object. The haptic effect can be various types of tactile effects. Once the user reaches the location of a first physical object, the mobile device 200, via the session, can dynamically generate and display a new interactive map indicating the second physical object disposed in the facility.

In some embodiments, the user can have further inquiries associated with various physical objects disposed in the facility. The user can communicate the inquiries by initiating further audible inputs, via the microphone 206. The mobile device 200 can transmit the audible inputs received, via the microphone 206, to the computing system 100. The control engine 320 can execute voice, speech and/or audio recognition and parse the audio inputs. The control engine 320 can determine one or more physical objects included in the audible inputs. The control engine 320 can query the physical objects database 330 to retrieve information associated with the physical objects included in the audible inputs. The control engine 320 can store the information associated with the physical objects in the sessions database 335 corresponding to the executed session associated with the mobile device. The mobile device 200 can receive, via the session, the information associated with the additional audible inputs and display the information on the interactive display 204.

In some embodiments, a printer can be connected to the computing system 100. The printer can be configured to print out the information displayed on the interactive display 102. In another embodiment, the computing system 100 can include speakers . The speakers 104 can be configured to generate audible feedback to the user. For example, in the event the control engine 320 is unable to parse the audible input from the user, the computing system 100 can output audible feedback from the speakers to repeat the audible input.

The user can terminate the session at any time using the mobile device 200. In response to the session being terminated, the control engine 220 can erase the session stored in the sessions database 335. In some embodiments, the session can be automatically terminated and erased from the sessions database 335 in response to determining the mobile device 200 is more than a specified distance from a facility. Furthermore, the session can be automatically terminated and erased from the sessions database 335 after a specified amount of time.

As a non-limiting example, the voice activated assistance system 250 can be implemented in a retail store. The computing system 100 can be a kiosk disposed in a retail store. A user can audibly speak into the microphone 104 and attempt to inquire about products disposed in the facility. The computing system 100 can receive the audible input from the microphone 104 and execute the control engine 320 in response to receiving the audible input. In response to, detecting the audible inquiry from the user, the control engine 320 can execute a session associated with the user. The control engine 320 can store the session in the sessions database 335. The control engine 320 can execute speech, voice or audio recognition on the audible input. The control engine 320 can use acoustic and linguistic modeling to execute the speech, voice or audio recognition. The control engine 320 can parse the audible input and determine whether the audible input is associated with one or more products disposed in the retail store. The control engine 320 can determine the audible input is associated with one or more products based on information associated with the products. The information can be one or more of: name, alphanumeric identifier, brand and/or type of products. In the event the computing system 100 cannot recognize the audible input the computing system 100 can discard the audible input.

The control engine 320 can query the physical objects database 330 to retrieve information associated with the products included in the audible input. The control engine 320 can store the information associated with the products included in the audible input in the sessions database 335 corresponding to the executed session. The control engine 320 can display information associated with the products on the interactive display. In some embodiments, the control engine 320 can display an interactive map on the interactive display 102, indicating the location of the at least one of the products within the retail store and directions to the product. In some embodiments, the interactive map can indicating the location of the of a first one of the products of the multiple products disposed in the retail store. The control engine 320 can also determine the locations of the remaining products. The control engine 320 can store the locations of the remaining products in the sessions database corresponding to the executed session can include the locations of the remaining products, so that when the user is able to locate the first products, the session generates a another interactive map indicating the location of the second or third product of the multiple products. The control engine 320 (via the communication device 110 as shown in FIG. 1) can detect a mobile device 200 within a specified distance. The mobile device can belong to the user communicating with the computing system 100. In some embodiments, the control engine 320 can detect the mobile device 200 based on detecting based on detecting the device that is generating the highest signal strength. The control engine 320 can pair with the mobile device, in response to receiving an affirmation to a permission request to pair with the mobile device. In some embodiments, the control engine 320 can transmit a message to the mobile device 200 requesting to pair with the mobile device 200. In response to receiving an affirmative response the mobile device 200 can pair with the computing system. Once the mobile device 200 and the computing device 100 are paired, the control engine 320 can associate the executed session with the user, with the mobile device 200.

The user, with the mobile device 200, can move away from the computing system 100 after receiving the requested information. In the event the computing system 100 has paired with the mobile device 200, the control engine 320 can detect the mobile device has moved away from the computing system 100 more than a specified distance. In response to determining, the mobile device 200 has moved away from the computing system 100 more than a specified distance, the control engine 320 can transfer the session from the computing system 100 to the mobile device 200. In response to the session being transferred to the mobile device 200, the information (such as the interactive map) can be displayed on an interactive display 204 of the mobile device 200.

In the event, an interactive map 202 is displayed on the interactive display 204 of the mobile device 200, the mobile device can dynamically provide interactive guidance and directions to the product. For example, mobile device 200 can have a location module to determine the location of the mobile device 200, and the interactive display 204 can display an indication of the location of the mobile device 200 as the user moves throughout the retail store. The mobile device 200 can provide audible directions to the user, as well as indicating directions on the interactive display 204. The mobile device 200 can also generate haptic effects using a haptic device to indicate the user is moving toward the product or moving away from the product. A different haptic effect can be generated if the user is moving toward the product as opposed to moving away from the product. The haptic effect can be various types of tactile effects. Once the user reaches the location of a first physical object, the mobile device 200, via the session, can dynamically generate and display a new interactive map indicating the second physical object disposed in the retail store.

In some embodiments, the user can have further inquiries associated with various physical objects disposed in the facility. The user can communicate the inquiries by initiating further audible inputs, via the microphone 206. The mobile device 200 can transmit the audible inputs received, via the microphone 206, to the computing system 100. The control engine 320 can execute voice, speech and/or audio recognition and parse the audio inputs. The control engine 320 can determine one or more products included in the audible inputs. The control engine 320 can query the physical objects database 330 to retrieve information associated with the products included in the audible inputs. The control engine 320 can store the information associated with the products in the sessions database 335 corresponding to the executed session associated with the mobile device. The mobile device 200 can receive, via the session, the information associated with the additional audible inputs and display the information on the interactive display 204.

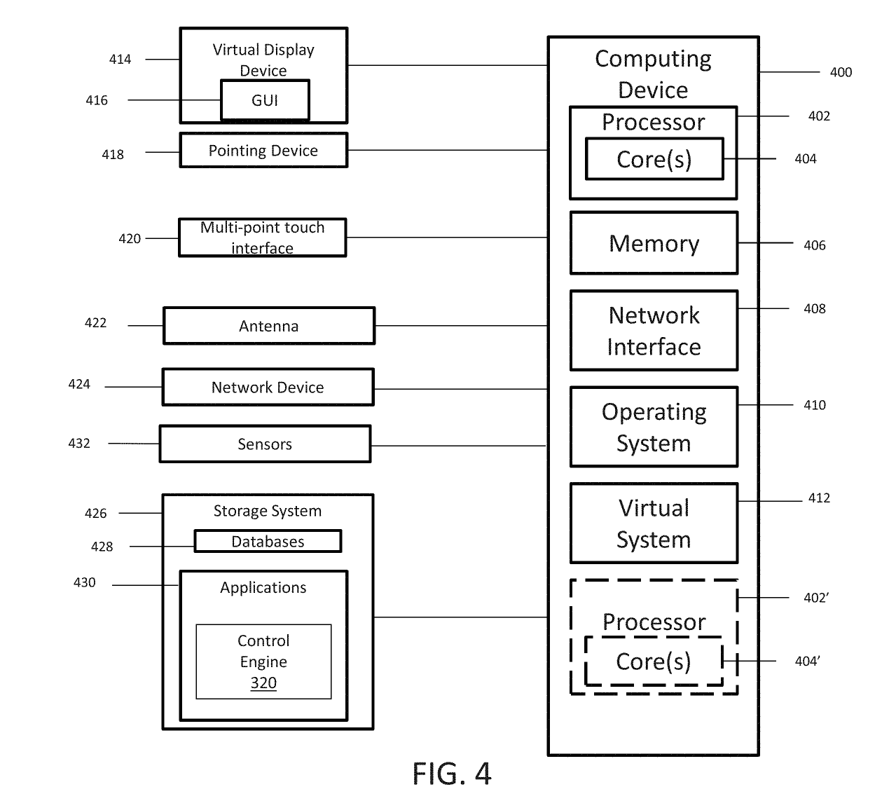

FIG. 4 is a block diagram of an exemplary computing device suitable for implementing embodiments of the automated shelf sensing system. The computing device 400 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 406 included in the computing device 400 may store computer-readable and computer-executable instructions or software (e.g., applications 430 such as the control engine 320) for implementing exemplary operations of the computing device 400. The computing device 400 also includes configurable and/or programmable processor 402 and associated core(s) 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 406 and other programs for implementing exemplary embodiments of the present disclosure. Processor 402 and processor(s) 402′ may each be a single core processor or multiple core (404 and 404′) processor. Either or both of processor 402 and processor(s) 402′ may be configured to execute one or more of the instructions described in connection with computing device 400.

Virtualization may be employed in the computing device 400 so that infrastructure and resources in the computing device 400 may be shared dynamically. A virtual machine 412 may be provided to handle a process running on multiple processors so that the process appears to be using only one computing resource rather than multiple computing resources. Multiple virtual machines may also be used with one processor.

Memory 406 may include a computer system memory or random access memory, such as DRAM, SRAM, EDO RAM, and the like. Memory 406 may include other types of memory as well, or combinations thereof. The computing device 400 can receive data from input/output devices such as, a reader 432.

A user may interact with the computing device 400 through a visual display device 414, such as a computer monitor, which may display one or more graphical user interfaces 416, multi touch interface 420 and a pointing device 418.

The computing device 400 may also include one or more storage devices 426, such as a hard-drive, CD-ROM, or other computer readable media, for storing data and computer-readable instructions and/or software that implement exemplary embodiments of the present disclosure (e.g., applications such as the control engine 320). For example, exemplary storage device 426 can include one or more databases 428 for storing information regarding the physical objects and sessions. The databases 428 may be updated manually or automatically at any suitable time to add, delete, and/or update one or more data items in the databases. The databases 428 can include information associated with physical objects disposed in the facility and the locations of the physical objects.

The computing device 400 can include a network interface 408 configured to interface via one or more network devices 424 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 422 to facilitate wireless communication (e.g., via the network interface) between the computing device 400 and a network and/or between the computing device 400 and other computing devices. The network interface 408 may include a built-in network adapter, network interface card, PCMCIA network card, card bus network adapter, wireless network adapter, USB network adapter, modem or any other device suitable for interfacing the computing device 400 to any type of network capable of communication and performing the operations described herein.

The computing device 400 may run any operating system 410, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 400 and performing the operations described herein. In exemplary embodiments, the operating system 410 may be run in native mode or emulated mode. In an exemplary embodiment, the operating system 410 may be run on one or more cloud machine instances.

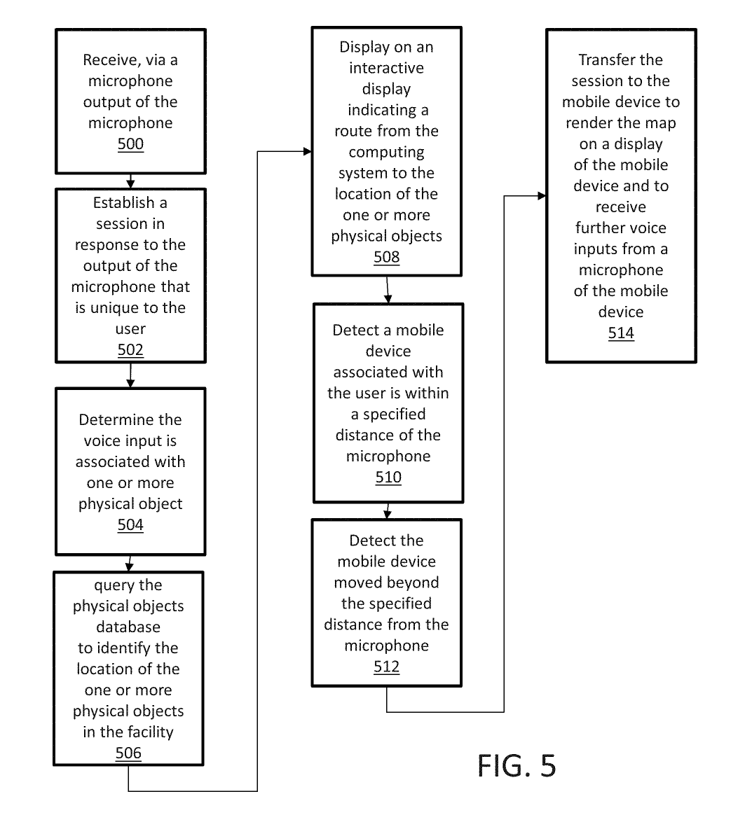

FIG. 5 is a flowchart illustrating a process of the voice activated assistance system according to an exemplary embodiment. In operation 500, a computing system (e.g. computing system 100 as shown in FIGS. 1 and 3) can receive, via a microphone (e.g. microphone 104 as shown in FIGS. 1 and 3), an output of the microphone. The output is generated in response to a voice input of a user. In operation 502, the computing system can establish a session in response to the output of the microphone that is unique to the user. In operation 504 a computing system can determine the voice input is associated with one or more physical object (e.g. physical object 106 as shown in FIG. 1) disposed in the facility. In operation 506, the executed session of the computing system query the physical objects database (e.g. physical objects database 330 as shown in FIG. 3) to identify the location of the one or more physical objects in the facility. In operation 508, the computing system can display on an interactive display (e.g. interactive display 102 as shown in FIGS. 1 and 3) a map (e.g. map 108 as shown in FIG. 1) indicating a route from the computing system to the location of the one or more physical objects in the facility. The map is associated with the session. In operation 510, the computing system can detect a mobile device (e.g. mobile device 200 as shown in FIGS. 2 and 3) associated with the user is within a specified distance of the microphone. The mobile device is initiating an application in response to being detected. In operation 512, the computing system can detect the mobile device moved beyond the specified distance from the microphone. In operation 514, the computing system can transfer the session to the mobile device to render the map on a display (e.g. interactive display 204 as shown in FIGS. 2 and 3) of the mobile device and to receive further voice inputs from a microphone (e.g. microphone 206 as shown in FIGS. 2 and 3) of the mobile device. Upon transferring the session, the microphone of the computing system can be released from the session so that it is available to be used to establish another session on the computing system with another user.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A voice activated assistance system in a retail facility, the system comprising:
a first microphone disposed at a specified location in a facility; and
a computing system in communication with the first microphone, the computing system including a database and an first interactive display, the computing system with an assistance environment programmed to:
receive an output of the first microphone, the output being generated in response to a voice input of a first user;
establish a first session in response to the output of the first microphone that is unique to the first user;
determine the voice input is associated with one or more physical object disposed in the facility;
query, via the first session, the database to identify the location of the one or more physical objects in the facility;
display on the first interactive display a map indicating a route from the computing system to the location of the one or more physical objects in the facility, wherein the map is associated with the first session;
detect a mobile device associated with the user is within a specified distance of the first microphone, the mobile device initiating an application in response to being detected;
detect the mobile device moved beyond the specified distance from the first microphone; and
transfer the first session from the computing system to the mobile device to render the map on a display of the mobile device and to receive further voice inputs from a second microphone of the mobile device in response to the detecting that the mobile device moved beyond the specified distance.

2. The system of claim 1, wherein the computing system is configured to:
render the map indicating the route from a location of the mobile device to the location of the one or more physical objects in the facility.

3. The system of claim 2, wherein the mobile device is configured to generate a haptic response effect in response to the mobile device moving towards or away from the location of the one or more physical objects.

4. The system of claim 1, wherein the computing system is configured to release the first microphone from the first session in response to transferring the first session to the mobile device.

5. The system of clam 4, wherein in response to receiving voice input from a second via the first microphone, the computing system is configured to establish a second session associated with the second user.

6. The system of claim 5, wherein the first and second sessions are executed concurrently by the computing system.

7. The system of claim 1, wherein the computing system is further programmed to determine the shortest route from the computing system to the location of the one or more physical objects.

8. The system of claim 1, further comprising a printer operatively coupled to the computing system, the printer being configured to:
receive instructions to print a set of information associated with the one or more physical objects; and
print the set of information associated with the one or more physical objects.

9. The system of claim 1, further comprising speakers operatively coupled to the computing system and disposed in proximity to the first microphone to provide audible feedback to the first user in response to the voice input.

10. A voice activated assistance method in a retail facility, the method comprising:
receiving, via a computing system in communication with a first microphone disposed in a specified location in a facility, the computing system including a database and an first interactive display and with an assistance environment, an output of the first microphone, the output being generated in response to a voice input of a first user;
establishing, via the computing system, a first session in response to the output of the first microphone that is unique to the first user;
determining, via the computing system, the voice input is associated with one or more physical object disposed in the facility;
querying, via the first session of the computing system, the database to identify the location of the one or more physical objects in the facility;
displaying, via the computing system, on the first interactive display a map indicating a route from the computing system to the location of the one or more physical objects in the facility, wherein the map is associated with the first session;
detecting, via the computing system, a mobile device associated with the user is within a specified distance of the first microphone, the mobile device initiating an application in response to being detected;
detecting, via the computing system, the mobile device moved beyond the specified distance from the first microphone; and
transferring, via the computing system, the first session to the mobile device to render the map on a display of the mobile device and to receive further voice inputs from a second microphone of the mobile device in response to detecting that the mobile device moved beyond the specified distance.

11. The method of claim 10, further comprising rendering, via the computing system, the map indicating the route from a location of the mobile device to the location of the one or more physical objects in the facility.

12. The method of claim 11, further comprising generating, via the mobile device, a haptic response effect in response to the mobile device moving towards or away from the location of the one or more physical objects.

13. The method of claim 10, further comprising releasing, via the computing system, the first microphone from the first session in response to transferring the first session to the mobile device.

14. The method of clam 13, further comprising establishing, via the computing system, a second session associated with the second user, in response to receiving voice input from a second via the first microphone.

15. The method of claim 14, wherein the first and second sessions are executed concurrently by the computing system.

16. The method of claim 10, further comprising determining, via the computing system, the shortest route from the computing system to the location of the one or more physical objects.

17. The method of claim 10, further comprising:
receiving, via the computing system, instructions to print a set of information associated with the one or more physical objects; and
printing, via a printer operatively coupled to the computing system, the set of information associated with the one or more physical objects.

18. The method of claim 10, further comprising providing, via speakers operatively coupled to the computing system and disposed in proximity to the first microphone, audible feedback to the first user in response to the voice input.
